(19) United States
(12) Patent Application Publication
(10) Pub. No.: US 2017/0295127 A1
(43) Pub. Date: Oct. 12, 2017

(54) SYSTEM AND METHOD FOR ACCESSING INFORMATION ITEMS

(71) Applicant: Dingchao He, Newark, DE (US)

(72) Inventor: Dingchao He, Newark, DE (US)

(21) Appl. No.: 15/483,412

(22) Filed: Apr. 10, 2017

Related U.S. Application Data
(60) Provisional application No. 62/320,075, filed on Apr. 8, 2016.

(51) Int. Cl. H04L 12/58; H04W 4/02; H04L 29/08

(52) U.S. Cl. CPC H04L 51/32; H04L 67/18; H04W 4/02; G06Q 50/01

(57) ABSTRACT

A system, method, and application for users to obtain or possess a geo-location as an asset for presenting one or more information items on a visual display map that are in geographic proximity to a user. The system is configured to receive posts of information items based on a poster's geographic location. The information items are dynamically updated in the system and have a limited lifespan to insure that the information contained in the system remain fresh and current. A user may find information items based on their geographic proximity to the item.

### CROSS-REFERENCE TO RELATED APPLICATION

This application claims the benefit of priority of U.S. provisional application No. 62/320,075, filed Apr. 8, 2016, the contents of which are herein incorporated by reference.

### BACKGROUND OF THE INVENTION

The present invention relates to information sources, and more particularly to information items that a user may be offering to a community of users or may be in need of receiving from a community of users.

Data and information sources such Craigslist, yelp, trip advisor, etc., do not support real time posting by users. Consequently, users can only receive information in general. Without real time updates, users do not get information concerning what is happening. Similarly, information in these data sources are not based on the user's location. As such, a user may have to sift through extraneous information that is not relevant for their needs. Another problem with prior information sources is that information is often dated, that is there is no expiration for the information, and again the user may need to sift through extraneous information that has expired and is not relevant to their needs

As can be seen, there is a need for a an information source that provides for posting and finding information that is based on real time updates, is geographically relevant, and has a pre-established expiration date. The users have ownership or control of the geographical location in this system. Other entities cannot access or take over the ownership, unless the other entity provides ownership proof.

### SUMMARY OF THE INVENTION

In one aspect of the present invention, a method for a service provider serving an exchange of information items, the method includes automatically receiving at a server of the service provider, in response to a post submission control activation on an app of a first mobile computer user, a post of an information item, the post comprising: a name for the information item, a description of the information item, and select demographic information corresponding to a profile of the first mobile computer user posting the information item; and a specified geographic location, as that of the ownership of the geographical location related to the account at registration, of the information item. The post is automatically stored in a database in communication with the server. The post is automatically communicated to a second mobile computer based on a geographic proximity of the geographic location of the information item and a geo-position coordinate of the second mobile computer.

The method may also include automatically presenting the post as an icon on a map carried on a display of the second mobile computer based on the geographic location of the post. The specified geographic location may be one of a real time geographic coordinate of the first mobile computer. Alternatively, the specified geographic location may be an address corresponding to one of a personal or a business profile of the first mobile computer user.

The method may also automatically remove the post after expiration of an expiration time specified for the post. The expiration time may be set by one of the first computer user or the service provider. The map of the second computer may be dynamically updated in response to a new post being received at the server with a distinguishing feature on the icon. The method may further include filtering the information items communicated to the second computer based on one or more filters specified by the second computer user.

Other aspects of the invention include a non-transitory computer-readable memory adapted for use by a service provider in serving an exchange of information items, the computer-readable memory used to direct a computer of the service provider to perform the steps of: automatically receiving at a server of the service provider, in response to a post submission control activation on an app of a first mobile computer user, a post of an information item, the post comprising: a name for the information item, a description of the information item, and select demographic information corresponding to a profile of the first mobile computer user posting the information item; and a specified geographic location the information item. The post is automatically stored in a database in communication with the server. The steps also include automatically communicating the post to a second mobile computer based on a geographic proximity of the geographic location of the information item and a geo-position coordinate of the second mobile computer. The post as may be automatically presented as an icon on a map carried on a display of the second mobile computer based on the geographic location of the post. The specified geographic location may include a real time geographic coordinate of the first mobile computer. Alternatively, the specified geographic location is obtained or possessed during the user's registration of one or more of a personal or a business profile of the first user. The steps can also include automatically removing the post after expiration of an expiration time specified for the post. The expiration time is set by one of the first computer user or the service provider. Additional steps may include, dynamically updating the map of the second computer in response to a new post being received at the server with a distinguishing feature icon. The information items communicated to the second computer may be filtered based on one or more filters specified by the second computer user.

Yet other aspects of the invention may include a computerized system for a service provider serving and exchange of information, the system includes means, at a server of the service provider for automatically receiving at a server of the service provider, in response to a post submission control activation on an app of a first mobile computer user, a post of an information item. The post includes a name for the information item, a description of the information item, and select demographic information corresponding to a profile of the first mobile computer user posting the information item; and a specified geographic location the information item. The system also has means for automatically storing the post in a database in communication with the server; and means for automatically retrieving one or more posts corresponding to a geo-position coordinate of a second mobile computer the specified geographic location of the information item. The system may also include means, at the server for automatically communicating the one or more corresponding posts to the second mobile computer. In addition the system may have means for automatically removing the post after expiration of an expiration time specified for the post.

These and other features, aspects and advantages of the present invention will become better understood with reference to the following drawings, description and claims.

### BRIEF DESCRIPTION OF THE DRAWINGS

FIG. 1 is a representative user interface for an application welcome screen.

FIG. 2 is a user interface for a user categorization selection.

FIG. 3 is a user interface is a user interface for an account home page.

FIG. 4 is a user interface for inputting an information item posting.

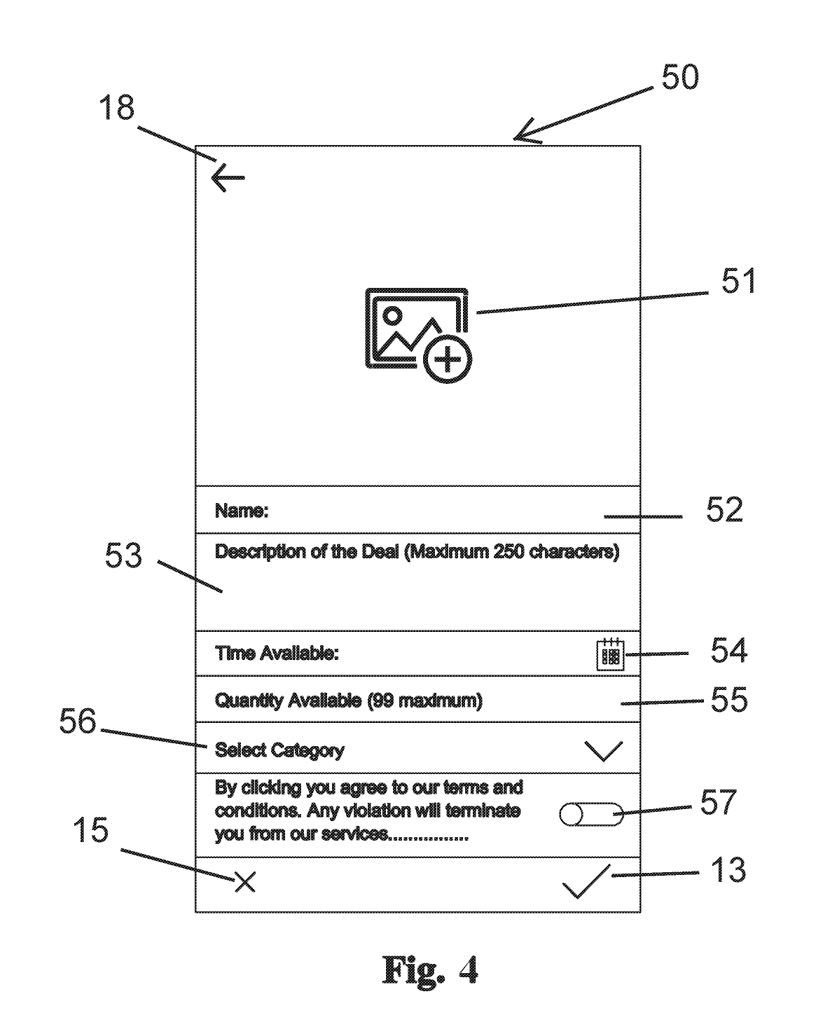

FIG. 5 is a user interface for an information item posting.

FIG. 6 is a user interface for an available item selection.

FIG. 7 is a user interface for a map find feature.

FIG. 8 is a user interface for a map filter selection.

FIG. 9 is a user interface for an available post selector.

FIG. 10 is a user interface for rating a poster.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provides a system, method, and user interface for a service provider serving web pages for receiving and exchanging postings of information or finding an item of information based on real time availability geographic location of a first user seeking an item and a geographic location of a second user having the item. Information items provided will expire after a pre-determined period of time to ensure that the information carried by the information service remains current. Information items may be posted to and retrieved from the system via an application via a graphical user interface (GUI). The application is preferably accessed via a mobile computing device, such as a smart phone or tablet, or other smart device, having global positioning system (GPS) or other location based reporting capabilities.

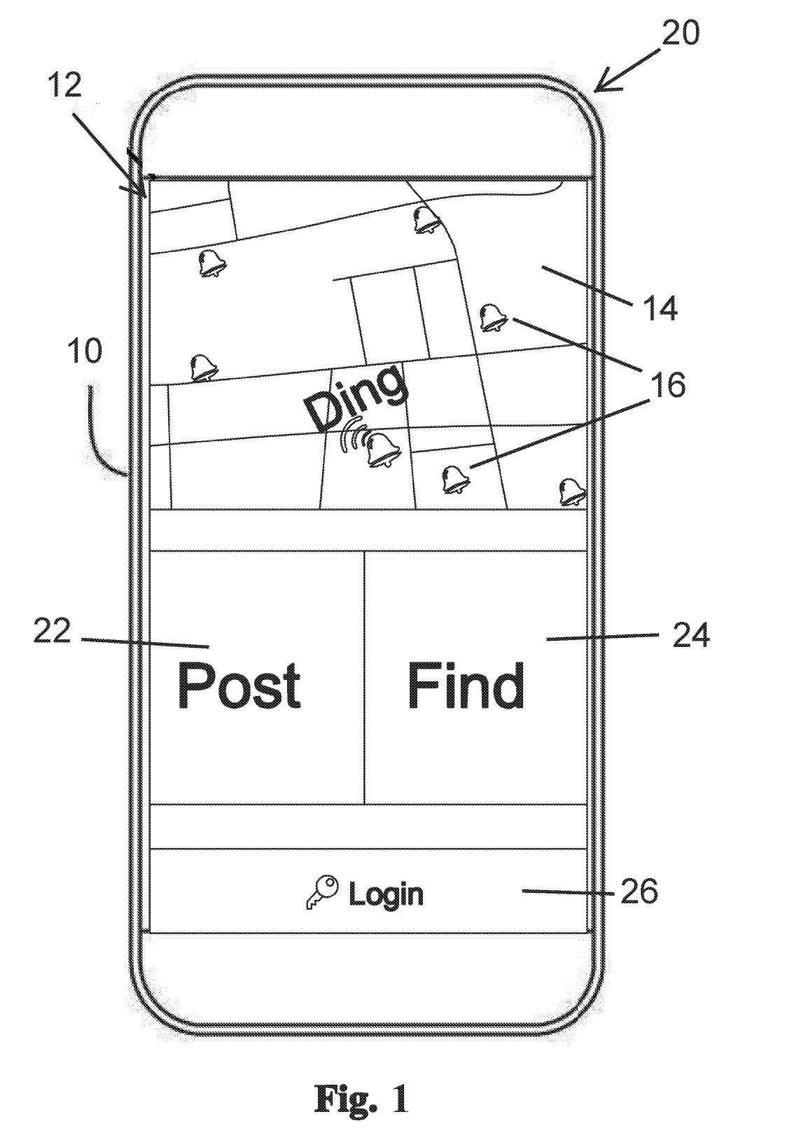

As will be appreciated from the side elevational view of FIG. 1, shows a welcome page user interface 20 for an application according to the present invention. The welcome screen 20 is configured to be accessed by one or more users accessing the application without logging in to their account. The welcome screen 20 provides a map 14 with one or more icons 16 representing the presence and location of information items 50 that have been posted and are still presently active to the system. The map 14 is presented based on location data for the user's and the information item's current location. A distinguishing feature may be presented with the icon 16 on the map 14, indicating the addition of a new information item.

In the welcome screen 20 a user is provided a control for selection options to post 22 an information item, find 24 an information item, or to login 26 to the system. If the user elects to access the system with their account credentials.

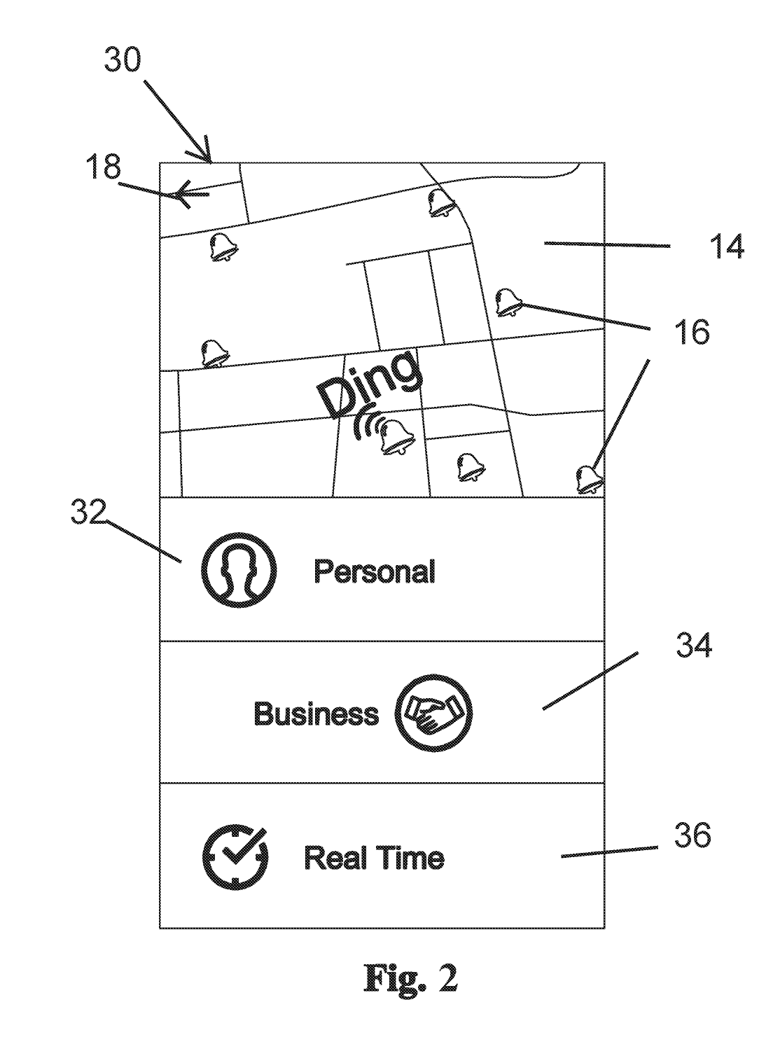

As seen in reference to FIG. 2, responsive to a welcome screen 20 selection, the user may be presented with a user status interface 30 presenting controls for categorizing the nature of the user's use of the application, for example the use may be for business 34 or personal 32 use, corresponding to a demographic profile of the user maintained by the system. The nature of use categorization may assist system users with finding or posting items relevant to a community of users who utilize the application. Within the system each user will have full control or possession of the geo-location they establish at registration. Another user or entity may establish their ownership of the geo-location by providing evidence to the system administrator to establish their ownership of the location. A real time control 36 is presented to allow a user to post or find an information item without providing a location for the information item. Others utilizing the system may then locate the information item by reference to the real time geographic coordinates of the mobile device of the user selecting the real time control 36. A return control 18 may be presented to allow the user to navigate to the welcome screen 20, or a previous screen on which the user accessed.

Upon a user's first interaction with the system and application requires the user to register with the system to fully participate with all the features provided. The user may be prompted to provide identity and demographic information. Once all or only required demographic information has been added, the user may press a submit control to transmit their identification and demographic information to the system.

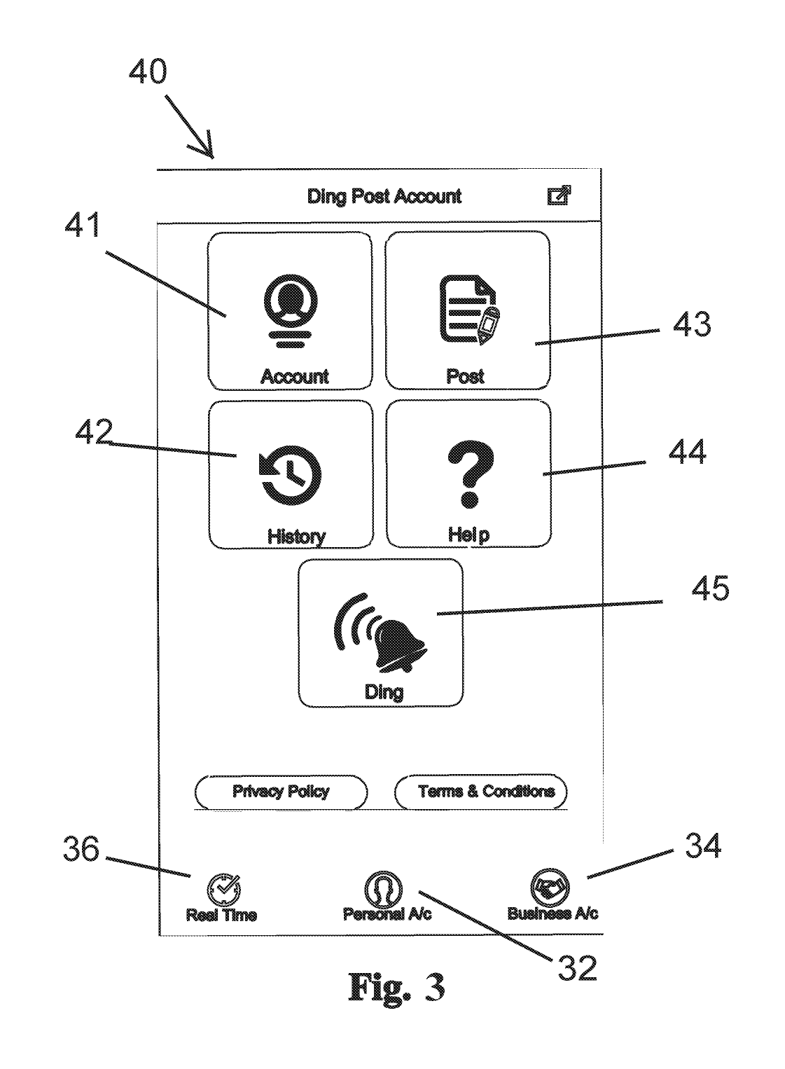

As seen in reference to FIG. 3, once a user has registered, or logged in with their credentials, the system presents a system navigation menu 40. The system navigation menu 40 presents controls for modules within the application. The options may include controls to view account information 41, change password, create a post 43 for an information item, access a ding module 45, view the user's history 42, learn about the system host, or contact the system host, or otherwise receive assistance via a help control 44. The user may also be presented controls to change or set their user categorization via personal 32, business 34 and real time 36 controls, as previously described.

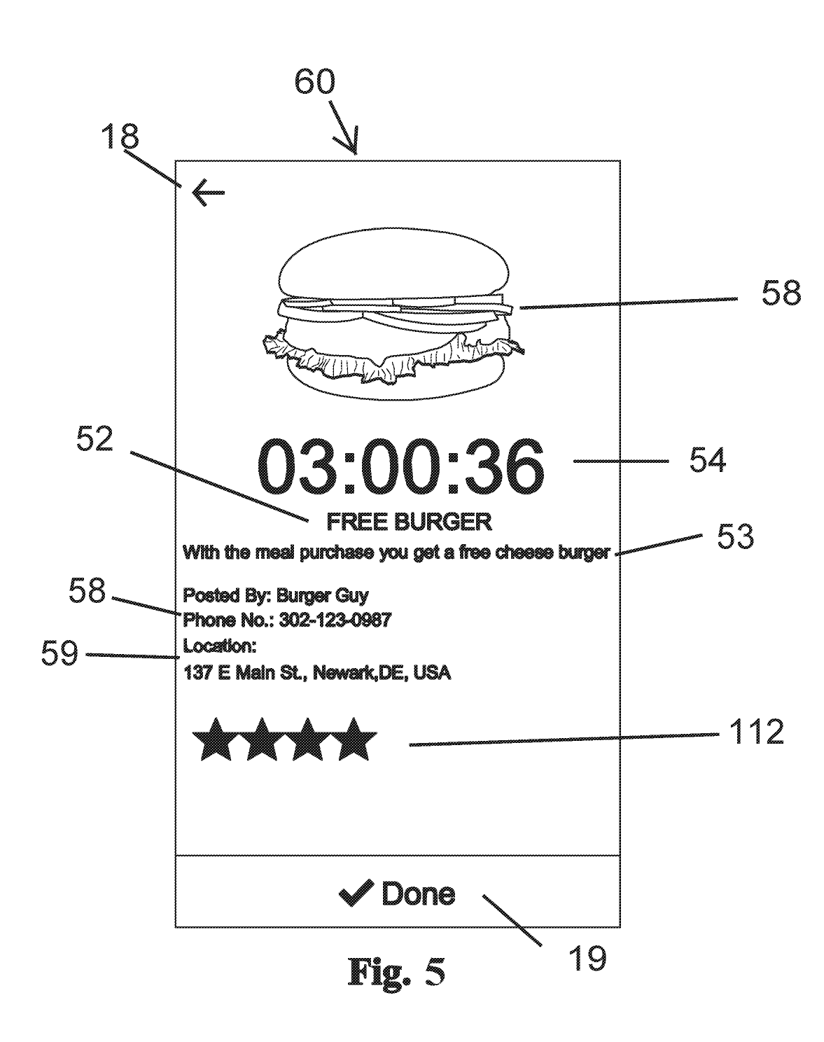

As seen in reference to FIG. 5, if a user has selected the post control 43 from the menu 40, the user is presented with a post interface 50 for entering information relating to an information item. An image input control 51 is presented, which when activated, enables the user to upload an image of the information item. The information item image 58 may be a pictorial representation of the information item, or any one of an icon, graphic, emoticon, or other graphical representation that may be associated with the information item to enable users of the system to recognize the information item. A name field control 52 is provided to prompt the user for a name to be associated with the information item. The user may enter a description of the information item in a description field 53. A time available control 54 allows the user to specify the time duration that the item 50 may be available. A quantity field 55 allows an input for the quantity of the items 50 available. A category control 56 may also be provided for the user to specify a category of the item, selected from a plurality of categories for classifying information items that are carried and maintained by the system. A confirmation control 13 is also presented. When the user activates the confirmation control 13, the poster is presented an information item review interface 60, which allows the poster to review their post before submitting it to the system to be posted. The posts are received at a server of the service provider and stored in a database in communication with the server. In some embodiments, a terms and conditions acceptance control 57 is provided, and may be set such that a user cannot post an information item without accepting the terms for each post the user initiates.

A representative information item review interface 60 is illustrated in reference to FIG. 5. The information item review display 60 includes a space for presenting the image 58 of the information item. A time available display 54 presents a countdown timer, which is updated in real time, to reflect how much time is remaining before the information item expires in the system. A plurality of poster fields 59 display the identity of the poster, a phone number associated with the poster and a location field. Each of the poster and location fields 59 are presented based on the poster's selected nature of use control 32, 34, or 36. If the user has selected the personal 32 or business 34 categories, the poster's phone number and location field 59 will display with the poster's demographic information associated with the respective nature of use specified by the user. If the post item is for a real time post 36, the actual location 59 for the poster will be presented for a search, the information item review display 60 or on a map display 80 showing information items within the system as described herein. A return control 18 returns the poster to the post interface 50, if needed to edit the information or to cancel posting the item. When the poster has confirmed that the information item is ready to be posted to the system, the poster presses a post submission control 19, which returns the user to the main menu 40. A rating display 112 may also be provided to display a rating of the poster.

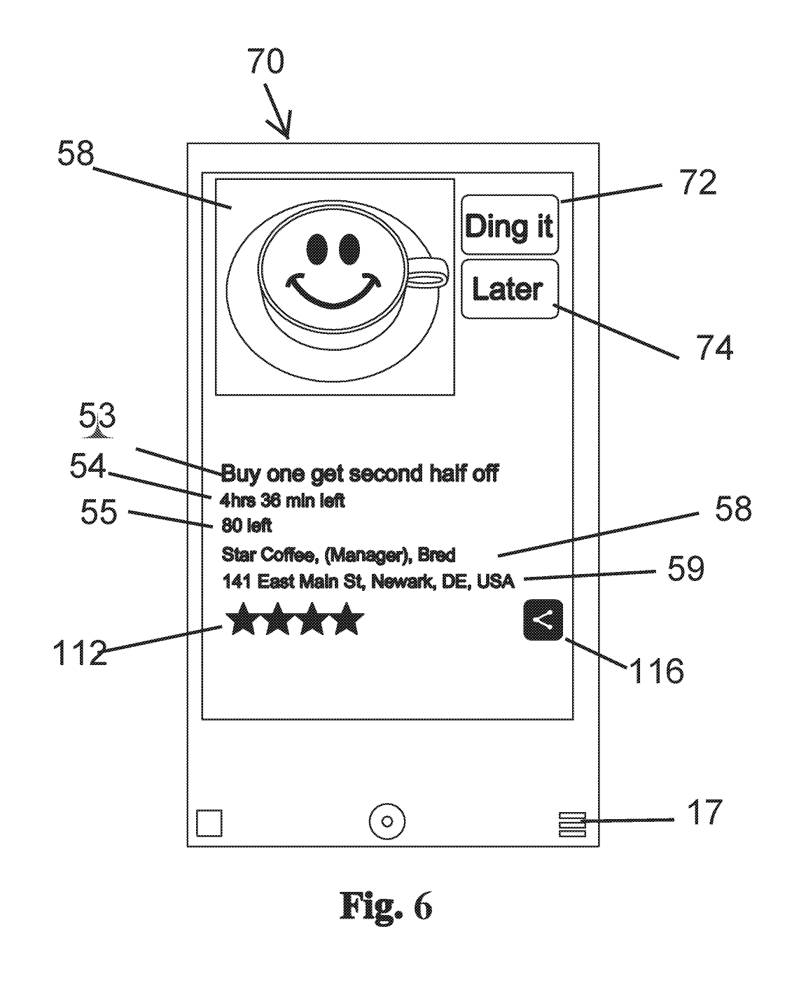

An information item detail interface 70 seen in reference to FIG. 6. The detail interface 70 presents the image 51, when provided, the description 53, the time available 54, a quantity remaining 55, and poster information 58 and location information 59. The detail interface 70 allows the user to select the information item for consumption or use with a accept control 72. The user may also decline or pass on an information item by selection of a decline control 74. A list control 17 permits the user to access an information items list display 100, which shows a listing information items in the user's proximity.

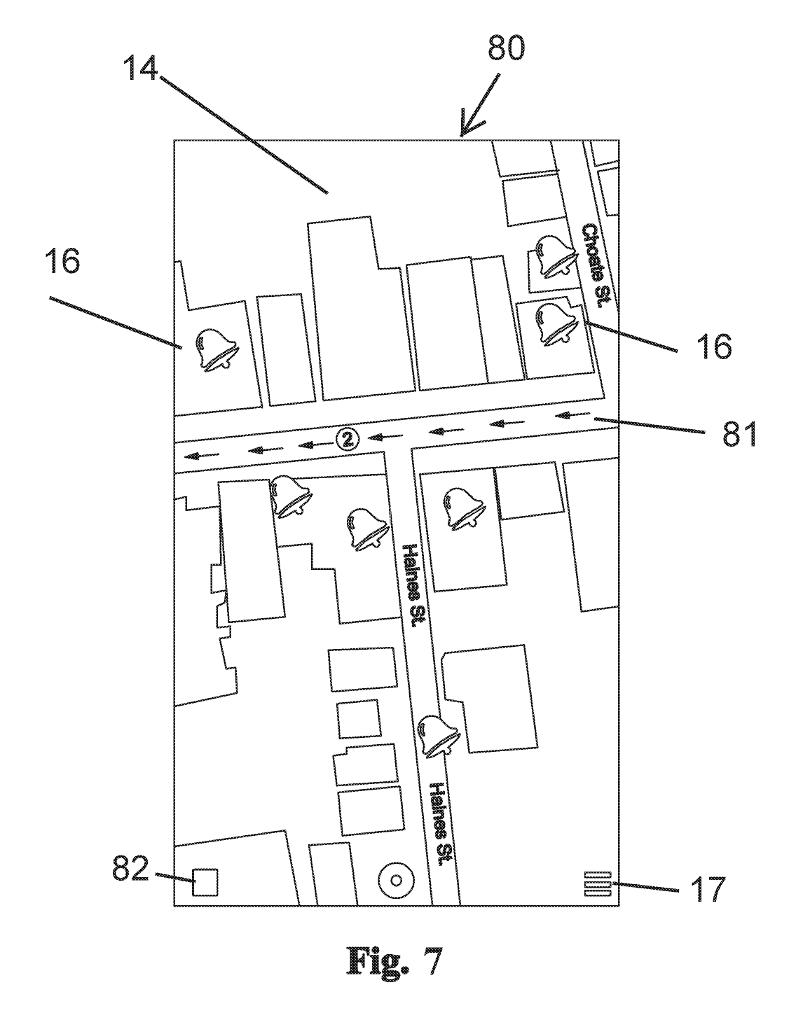

If a user has selected a find 24 from the welcome screen 20 or a “ding” control 45 from the main menu 40, the application user interface presents a map interface 14 in the display 12 of the device 10 such as shown in reference to FIG. 7. The map interface 80 may show the user's current location based on the device's location data that is sent to the system. The map display 80 will indicate one or more icon controls 16, such as the “ding” bell illustrated. Each icon control 16 represents currently available information items in geographic proximity to the user as well as the location 59 corresponding to the information item.

The user may activate any of the icon controls 16 to obtain more detail about that item, in which case, the detail interface 70 may be presented. If the user performs a gesture, such as pressing and holding the icon control 16, the image 58 corresponding to the information item may be presented on the map display 14 to provide a quick visual reference of what the information item may pertain to and enable the user to quickly determine if they have any interest in the information item. When a user has selected an item, the map 14, may provide guidance instructions 81 to enable the user to navigate from their current location to the location 59 for the item.

If the user wants to change the geographic area of their search, they may perform a gesture on the map display 80 to perform various functions, such as zoom in, zoom out, or pan the map 14 in a desired direction. The may display 80 will dynamically update the map 14 based on the gesture and/or the user's position. The user may also operate a map filter control 82 which activates a filter user interface 90.

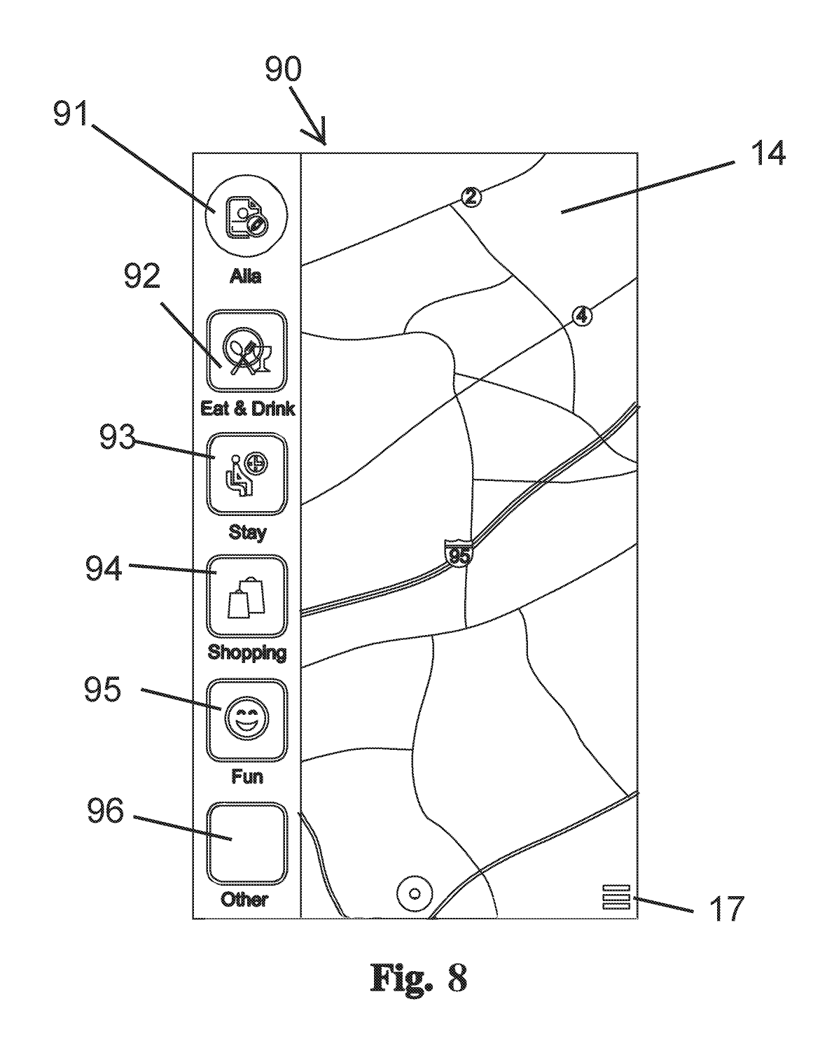

The filter user interface 90 shown in reference to FIG. 8 permits the user to select from one or more of the system specified categories 56 for filtering the information items shown on the map 14 corresponding to the selected categories. The settings menu presents the user a plurality of application settings for controlling the information that is presented on the map display interface 80. By way of non-limiting example the filter may be a particular user 91, restaurants or drinking establishments 92, lodging 93, shopping 94, entertainment 95, and may also include user definable filters 96.

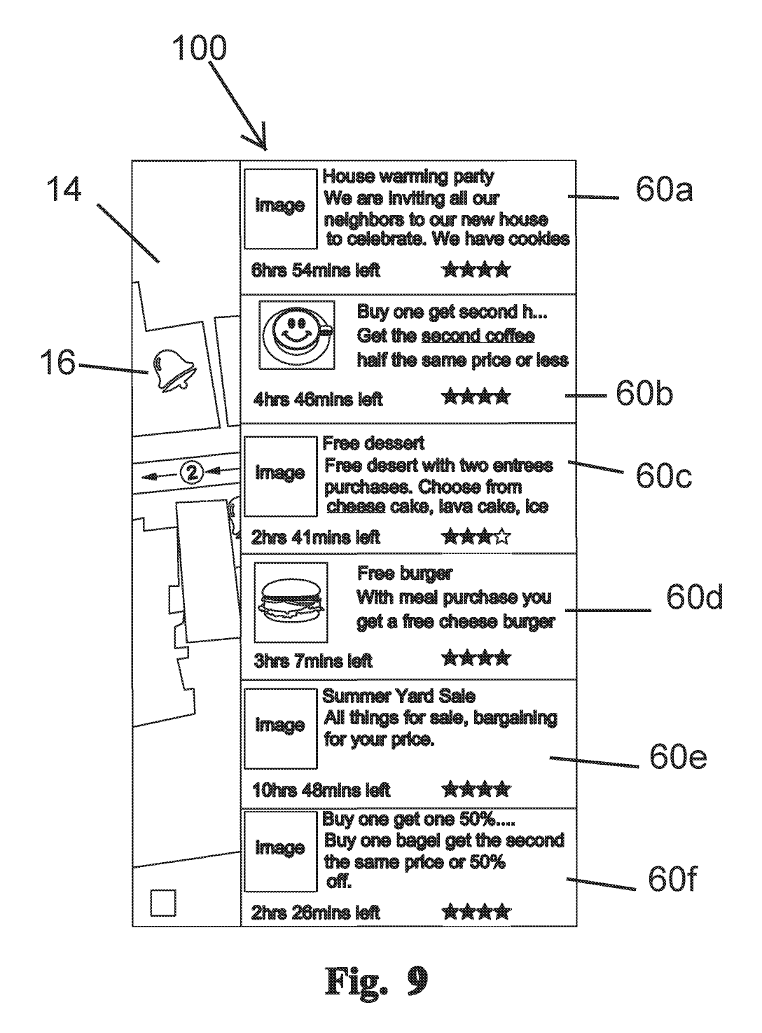

The map display 80 of FIG. 7, may also include a list control 17, which if activated by the user, will present a list display 100, such as shown in reference to FIG. 9, of the information items that were graphically displayed on the map 14. That is, a list item 60a-60f for each of the item icons 16 presented on the map 14. The list items 60a-60f present additional information corresponding to the icon 16. For example, the list items 60a-60f may include a description of the item, (monopoly game card, lip balm, or a coin for trade). The list item display 100 will also present an expiration time for the items, which may be expressed as a countdown timer representation. The list item display 100 may also present whether the user is selling or presenting an item, or whether the user may be in need of an item. The display 100 may also include a rating 112 of the user associated with the item, or a rating of the item offered by the user. Selection of any of the list items 60a-60f may either take the user to the detail interface 70, where the user may accept or decline the item. A gesture may also be performed on a selected list item such that the user is presented with an accept 72 or decline 74 control within the list item.

As seen in reference to FIG. 9, user selection of a list item 60a-60f provides additional details regarding the user associated with the list item and/or additional information regarding the list item, such as a quantity available. The user may choose the item, by for example via a “Ding It” control. The user may also select an item the user may have an interest in obtaining by selecting a “Later” control. The user may also share an item via a link control 116 linking the item to, for example, a social media account associated with the user. If the user chooses an item, such as by “Dinging” it, they are provided a screen that allows the user to use the information item.

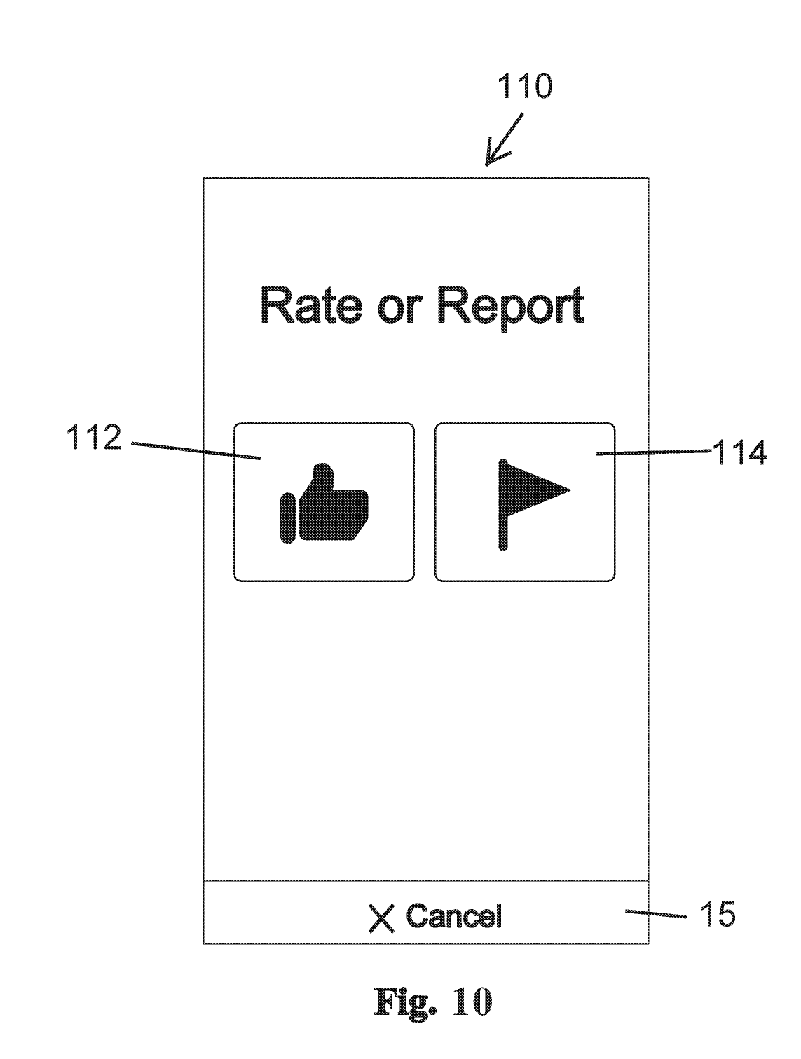

As seen in reference to FIG. 10, the system may also allow users to rate their experience with an information item or a source of the information item. A plurality of controls are presented for making the rating. For example, for a good rating, a green thumbs up control 112 may be presented for the user to activate to indicate a good experience. The display may include an unfavorable rating control 114, such as a red flag icon, to indicate a bad experience with the vendor or the information item. The system may be configured to eliminate a user's access to the system for a pre-determined time period if the user receives one or more unfavorable ratings. A cancel control 15 allows the user to return to a previous screen.

The system of the present invention may include at least one computer with a user interface. The computer may include any computer including, but not limited to, a desktop, a mobile device, a laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable memory and executed as a computer program on a general purpose or special purpose computer. For clarity, only those aspects of the system germane to the invention are described, and product details well known in the art are omitted. For the same reason, the computer hardware is not described in further detail.

It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for a service provider serving an exchange of information items, the method comprising:
automatically receiving at a server of the service provider, in response to a post submission control activation on an app of a first mobile computer user, a post of an information item, the post comprising:
a name for the information item, a description of the information item, and select demographic information corresponding to a profile of the first mobile computer user posting the information item; and
a specified geographic location the information item;
automatically storing the post in a database in communication with the server; and
automatically communicating the post to a second mobile computer based on a geographic proximity of the geographic location of the information item and a geo-position coordinate of the second mobile computer.

2. The method of claim 1, further comprising:
automatically presenting the post as an icon on a map carried on a display of the second mobile computer based on the geographic location of the post.

3. The method of claim 1, wherein the specified geographic location comprises:
a real time geographic coordinate of the first mobile computer.

4. The method of claim 3, wherein the specified geographic location comprises:
an address corresponding to one of a personal or a business profile of the first mobile computer user.

5. The method of claim 1, further comprising:
automatically removing the post after expiration of an expiration time specified for the post.

6. The method of claim 5, wherein the expiration time is set by one of the first computer user or the service provider.

7. The method of claim 1, further comprising:
dynamically updating the map of the second computer in response to a new post being received at the server with a distinguishing feature on the icon.

8. The method of claim 1, further comprising:
filtering the information items communicated to the second computer based on one or more filters specified by the second computer user.

9. A non-transitory computer-readable memory adapted for use by a service provider in serving an exchange of information items, the computer-readable memory used to direct a computer of the service provider to perform the steps of:
automatically receiving at a server of the service provider, in response to a post submission control activation on an app of a first mobile computer user, a post of an information item, the post comprising:
a name for the information item, a description of the information item, and select demographic information corresponding to a profile of the first mobile computer user posting the information item; and
a specified geographic location the information item;
automatically storing the post in a database in communication with the server;
automatically communicating the post to a second mobile computer based on a geographic proximity of the geographic location of the information item and a geo-position coordinate of the second mobile computer.

10. The computer-readable memory of claim 9, further comprising:
automatically presenting the post as an icon on a map carried on a display of the second mobile computer based on the geographic location of the post.

11. The computer-readable memory of claim 9, wherein the specified geographic location comprises:
a real time geographic coordinate of the first mobile computer.

12. The computer-readable memory of claim 9, wherein the specified geographic location comprises:
an address corresponding to one of a personal or a business profile of the first mobile computer user.

13. The computer-readable memory of claim 9, further comprising:
automatically removing the post after expiration of an expiration time specified for the post.

14. The computer-readable memory of claim 13, wherein the expiration time is set by one of the first computer user or the service provider.

15. The computer-readable memory of claim 9, further comprising:
dynamically updating the map of the second computer in response to a new post being received at the server with a distinguishing feature icon.

16. The computer-readable memory of claim 9, further comprising:
filtering the information items communicated to the second computer based on one or more filters specified by the second computer user.

17. A computerized system for a service provider serving and exchange of information, the system comprising:
means, at a server of the service provider for automatically receiving at a server of the service provider, in response to a post submission control activation on an app of a first mobile computer user, a post of an information item, the post comprising:
a name for the information item, a description of the information item, and select demographic information corresponding to a profile of the first mobile computer user posting the information item; and
a specified geographic location the information item;
means for automatically storing the post in a database in communication with the server; and
means for automatically retrieving one or more posts corresponding to a geo-position coordinate of a second mobile computer the specified geographic location of the information item.

18. The computerized system of claim 17, further comprising:
means, at the server for automatically communicating the one or more corresponding posts to the second mobile computer.

19. The computerized system of claim 18, further comprising
means for automatically removing the post after expiration of an expiration time specified for the post.
